(19) United States
(12) Patent Application Publication
(10) Pub. No.: US 2024/0363092 A1
(43) Pub. Date: Oct. 31, 2024

(54) SENSOR MODULE, ACTIVE CONTROL DEVICE, ACTIVE CONTROL METHOD, AND PROGRAM

(71) Applicant: SONY GROUP CORPORATION, TOKYO (JP)

(72) Inventors: SHIGETOSHI HAYASHI, TOKYO (JP); TETSUNORI ITABASHI, TOKYO (JP); TETSU MAGARIYACHI, TOKYO (JP); YOSHIYUKI KURODA, TOKYO (JP); KOYA SATO, TOKYO (JP)

(21) Appl. No.: 18/291,276

(22) PCT Filed: Feb. 22, 2022
(86) PCT No.: PCT/JP2022/007158

§ 371 Date: Jan. 23, 2024

(30) Foreign Application Priority Data
Aug. 20, 2021 (JP) 2021-134578

(51) Int. Cl. G10K 11/178; H04R 19/04

(52) U.S. Cl. CPC G10K 11/17825; G10K 11/17823; G10K 11/17881; H04R 19/04; G10K 2210/129; G10K 2210/3026; G10K 2210/3027; G10K 2210/3028; H04R 2201/003

(57) ABSTRACT

For example, active control can be easily performed at low cost. A sensor module includes: a first sensor unit that is installed on an object and measures a sound pressure; a second sensor unit that is installed on the object and measures vibration; and a signal processing unit that outputs, as module signals, two signals of a signal of a vibration component of the object and a signal of a sound pressure component obtained by removing the vibration component of the object from an output signal of the first sensor unit by using the output signal of the first sensor unit and an output signal of the second sensor unit.

### TECHNICAL FIELD

The present disclosure relates to a sensor module, an active control device, an active control method, and a program.

### BACKGROUND ART

In recent years, a technique called spatial noise control (NC: Noise Control) has attracted attention as a technique for creating a quiet space. The spatial noise control is roughly divided into active control (also referred to as active control) realized by using a drive unit such as a speaker and passive control (also referred to as passive control) realized by using a sound absorbing material, a sound insulating material, a vibration damping material, a vibration damping material, or the like and optimizing the shape without using the drive unit. It is known that the active control is an effective means in a low-frequency band in which the effect is low (specifically, the realization is difficult due to low efficiency, large size, and high cost) in the passive control.

In conventional headphone NC, noise reduction by active control is realized using, for example, a microphone that collects sound as a sensor and a speaker for controlling noise at an eardrum position as a control target.

On the other hand, there is a case where acoustic radiation derived from vibration of an object cause noise. In this case, it is possible to expand control space by setting the object itself that radiates sound as a control target and actively controlling the vibration itself of the control target.

In order to control such vibration-derived noise from an object, a sensor is required as a device for measurement. As this sensor, a sensor capable of measuring information such as particle velocity and sound pressure in the vicinity of the surface of the object to be controlled is desirable. For example, Non-Patent Document 1 below discloses a technique using both information of sound pressure and particle velocity detected by a sensor.

### CITATION LIST

### Non-Patent Document

Non-Patent Document 1: Andrea Grosso, Daniel Fernandez Comesana and Hans-Elias De Bree, “Further Development of the PNCA: New Panel Noise Contribution Reference-Related (PNCAR)”, SAE Int. J. Passeng. Cars-Mech. Syst. 5(2): 2012, doi:10.4271/2012-01-1539.

### SUMMARY OF THE INVENTION

### Problems to be Solved by the Invention

In the case of recording the particle velocity described above using a particle velocity sensor, it is desirable to measure a plurality of points with a constant distance from the object surface, but in this case, there are the following problems.

The particle velocity sensor is very expensive compared to a microphone, an acceleration sensor, and the like. Therefore, the use of the particle velocity sensors for a large number of measurement points increases the cost.

Furthermore, since the particle velocity sensor is usually installed in a non-contact manner with the vibrating object and used in a state where vibration insulation is performed, it is difficult to install a plurality of particle velocity sensors at a constant distance from the object surface.

An object of the present disclosure is to enable easy active control at low cost.

### Solutions to Problems

The present disclosure provides, for example,
a sensor module including:
a first sensor unit that is installed on an object and measures a sound pressure;
a second sensor unit that is installed on the object and measures vibration; and
a signal processing unit that outputs, as module signals, two signals of a signal of a vibration component of the object and a signal of a sound pressure component obtained by removing the vibration component of the object from an output signal of the first sensor unit by using the output signal of the first sensor unit and an output signal of the second sensor unit.

The present disclosure provides, for example,
an active control device controlling an actuator in an active control system by using a module signal output from a sensor module, the sensor module including:
a first sensor unit that is installed on an object and measures a sound pressure; a second sensor unit that is installed on the object and measures vibration; and a signal processing unit that outputs, as module signals, two signals of a signal of a vibration component of the object and a signal of a sound pressure component obtained by removing the vibration component of the object from an output signal of the first sensor unit by using the output signal of the first sensor unit and an output signal of the second sensor unit.

The present disclosure provides, for example,
an active control method controlling an actuator in an active control system by using a module signal output from a sensor module, the sensor module including:
a first sensor unit that is installed on an object and measures a sound pressure; a second sensor unit that is installed on the object and measures vibration; and a signal processing unit that outputs, as module signals, two signals of a signal of a vibration component of the object and a signal of a sound pressure component obtained by removing the vibration component of the object from an output signal of the first sensor unit by using the output signal of the first sensor unit and an output signal of the second sensor unit.

The present disclosure provides, for example
a program for causing a computer to execute processing of controlling an actuator in an active control system by using a module signal output from a sensor module, the sensor module including:
a first sensor unit that is installed on an object and measures a sound pressure; a second sensor unit that is installed on the object and measures vibration; and a signal processing unit that outputs, as module signals, two signals of a signal of a vibration component of the object and a signal of a sound pressure component obtained by removing the vibration component of the object from an output signal of the first sensor unit by using the output signal of the first sensor unit and an output signal of the second sensor unit.

### BRIEF DESCRIPTION OF DRAWINGS

FIG. 1 is a diagram illustrating classification of a sensor and a control target in noise control with active control.

FIG. 2 is a view illustrating a vibration mode and a shape of a panel.

FIG. 3 is an image diagram visualizing acoustic intensity.

FIG. 4 is an explanatory diagram for explaining a correlation between particle velocity in the vicinity of an object surface and vibration velocity of the object.

FIG. 5 is a diagram illustrating a schematic configuration example of a sensor module according to a first embodiment.

FIG. 6 is a diagram illustrating a specific configuration example of the sensor module.

FIG. 7 is a diagram illustrating another specific configuration example of the sensor module.

FIG. 8 is a diagram illustrating a schematic configuration example of a sensor module according to a second embodiment.

FIG. 9 is a diagram illustrating a schematic configuration example of a sensor module according to a third embodiment.

FIG. 10 is a diagram illustrating a schematic configuration example of a sensor module according to a fourth embodiment.

FIG. 11 is a diagram illustrating a schematic configuration example of a sensor module according to a fifth embodiment.

FIG. 12 is a diagram illustrating a system configuration example in a recording phase of a first use example.

FIG. 13 is a diagram illustrating an installation example of the sensor module.

FIG. 14 is a functional block diagram illustrating a configuration example of a measurement device in the first use example.

FIG. 15 is a diagram illustrating features due to a difference in the number of the sensor modules.

FIG. 16 is a diagram illustrating a configuration example of an active control system of the first use example.

FIG. 17 is a view illustrating a setting example of a device.

FIG. 18 is a functional block diagram illustrating the configuration example of the active control system of the first use example.

FIG. 19 is a flowchart illustrating a flow of processing in the active control system of the first use example.

FIG. 20 is a diagram illustrating a hardware configuration example of an information processing device.

FIG. 21 is a diagram illustrating a system configuration example in a recording phase of a second use example.

FIG. 22 is a functional block diagram illustrating a configuration example of a measurement device in the second use example.

FIG. 23 is a functional block diagram illustrating a configuration example of a sound pressure estimation unit in a case where machine learning is used.

FIG. 24 is a diagram illustrating a configuration example of an active control system of the second use example.

FIG. 25 is a functional block diagram illustrating the configuration example of the active control system of the second use example.

FIG. 26 is a flowchart illustrating a flow of processing in the active control system of the second use example.

FIG. 27 is a diagram illustrating a route example of noise transmission between adjacent conference rooms.

FIG. 28 is a diagram for explaining transmitted energy in a case where a wall is vibrated by sound and becomes noise.

FIG. 29 is a diagram illustrating a route example of noise transmission between other adjacent conference rooms.

### MODE FOR CARRYING OUT THE INVENTION

Hereinafter, an embodiment and the like of the present disclosure will be described with reference to the drawings. Note that an embodiment and the like to be described below is a preferred specific example of the present disclosure, and the content of the present disclosure is not limited to this embodiment and the like. In the following description, components having substantially the same functional configuration are denoted by the same reference sign, and redundant description will be omitted as appropriate. The description will be given in the following order.
<1. Problems to be Considered in Embodiments>
<2. First Embodiment>
<3. Second Embodiment>
<4. Third Embodiment>
<5. Fourth Embodiment>
<6. Fifth Embodiment>
<7. First Use Example of Sensor Module>
<8. Second Use Example of Sensor Module>
<9. Third Use Example of Sensor Module>
<10. Modifications>

### 1. Problems to be Considered in Embodiments

First, problems to be considered in embodiments will be described below to facilitate understanding of the embodiments.

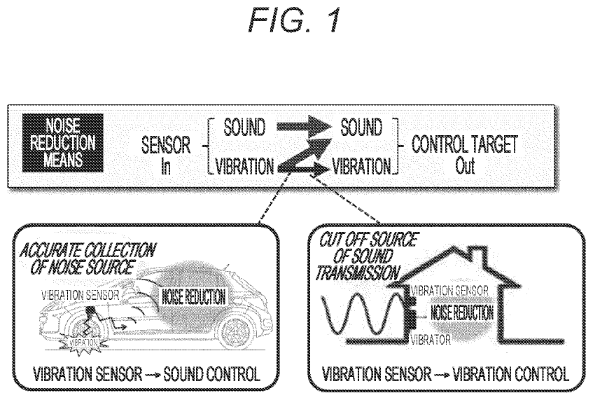

FIG. 1 illustrates classification of a sensor and a control target in noise control with active control. As a method for reducing noise, for example, the method is roughly classified into two methods. First, sound is input (detected) by a sound sensor such as a microphone and output (sound control) from a control target such as a speaker. Second, vibration is input by a vibration sensor such as an acceleration sensor, and sound is output from a control target such as a speaker. Third, vibration is input by a vibration sensor such as an acceleration sensor, and vibration of a control target such as a panel is controlled by excitation with an actuator.

In a case where acoustic radiation due to vibration of an object is a cause of noise, the control space can be expanded by actively controlling the vibration itself of the target as described above (vibration sensor→vibration control in FIG. 1).

By the way, as a major premise in the vibration control, if the vibration of the object can be completely reduced to zero at all points, the noise to be radiated corresponding to the vibration can also be reduced to zero. However, since an infinite number of resources are theoretically required for a control device such as an actuator and a sensor module such as an acceleration sensor, and the number of devices practically has an operational upper limit, it is difficult to control the vibration level to zero in all points.

Therefore, a method of minimizing acoustic radiation power from the object as an evaluation target instead of using the vibration level itself of the object as an evaluation target has been proposed in Non-Patent Document 2 below and the like.
Non-Patent Document 2: Joseph Milton, Jordan Cheer, and Steve Daley, “Experimental identification of the radiation resistance matrix”, The Journal of the Acoustical Society of America 145, 2885 (2019); https://doi.org/10.1121/1.5102167.

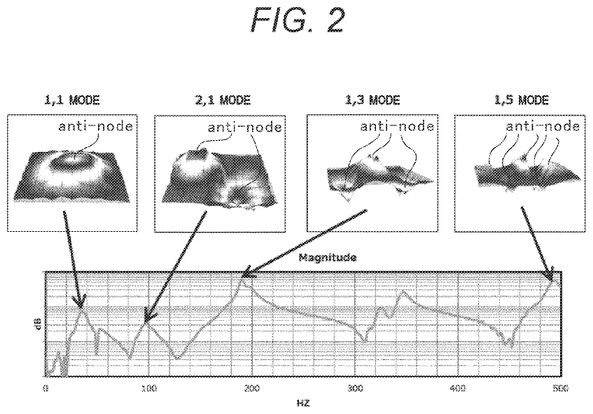

FIG. 2 is a view illustrating a vibration mode and a shape of a panel. FIG. 2 is a diagram plotting acceleration of vibration in a flat plate. In the graph in FIG. 2, the vertical axis represents the amplitude value (dB), and the horizontal axis represents the frequency (Hz). As illustrated in the drawing, it can be seen that the vibration level of the object increases at a frequency at which resonance called a vibration mode occurs, and that “anti-nodes” of vibrations swinging in phases opposite to each other occur in the vibration mode.

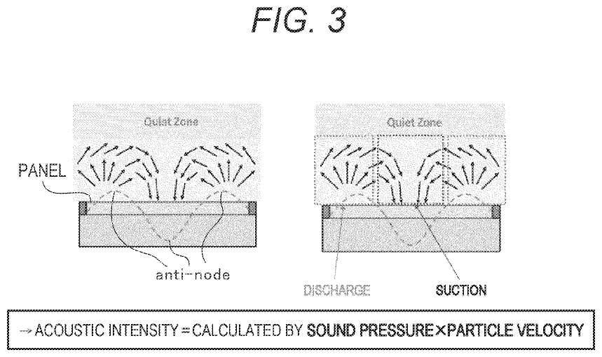

FIG. 3 is an image diagram visualizing “1,3 mode” in FIG. 2 from the viewpoint of acoustic intensity. Arrows in FIG. 3 represent acoustic intensity. The acoustic intensity is a vector quantity calculated by “sound pressure×particle velocity”. Note that the broken line waveform in the drawing is an exaggerated representation of the panel shaking.

From this drawing, it is possible to grasp the acoustic intensity flow in the vibration mode and the discharge and suction of energy. As can be seen from FIG. 3, energy is exchanged between the “antinodes” (between adjacent “antinodes”) of the modes in which the vibrations amplitude in phases opposite to each other, and it can be imagined that noise is not radiated to a distant sound field if this energy flow is appropriately controlled.

That is, in order to control the acoustic energy (acoustic radiation power) radiated from the vibrating object, it is important to acquire data of both “sound pressure and particle velocity”. Also in Non-Patent Document 2 described above, control focusing on this acoustic energy is performed. That is, focusing on both the “sound pressure and particle velocity”, the acoustic energy radiated from the object is obtained by a measurement system.

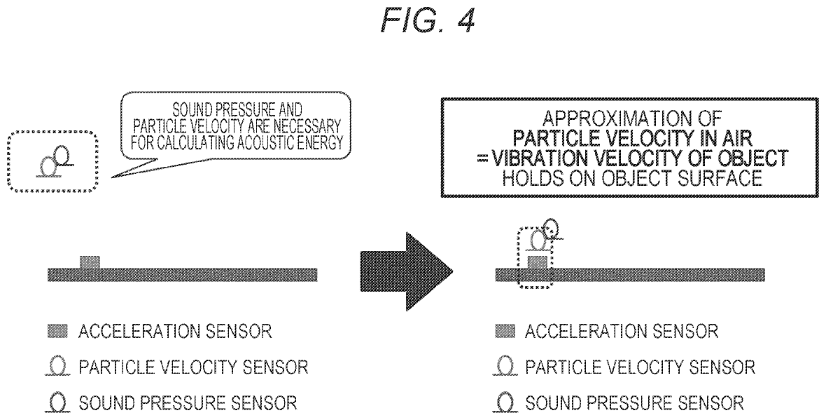

Moreover, in Non-Patent Document 2, it is disclosed that there is a strong correlation between the particle velocity on the surface of the vibrating object and the vibration acceleration (in other words, the differential value of the vibration velocity) of the object. More specifically, it is disclosed that the approximation of “particle velocity on object surface=vibration velocity of object (the integral value of acceleration)” holds in the vicinity of the object surface. That is, as illustrated in FIG. 4, it is disclosed that when the sound pressure to be measured is close to the surface of the object, the acoustic radiation power can be calculated using the sound pressure signal and the vibration acceleration of the object.

Here, advantages of using both information of the sound pressure and the particle velocity will be described. Non-Patent Document 1 described above proposes a technique for estimating sound pressure at the ear position of the driver in a vehicle interior. In Non-Patent Document 1, it is disclosed that, in the estimation of the sound pressure, the use of both the information of “sound pressure+particle velocity” has higher estimation performance in a high frequency range of 500 Hz or more compared with the case where only the information of “particle velocity (or vibration velocity)” is used.

This is because, as in the case of calculating the acoustic radiation power in Non-Patent Document 2, the spatial information can be calculated more accurately by using both the information of the “sound pressure and the particle velocity”. This also shows that it is important to acquire both the information of “sound pressure+particle velocity” on the object surface.

However, there is a problem in actually introducing a system that uses both the information of “sound pressure+particle velocity”. For example, when the particle velocity sensor is fixed, vibration insulation with a vibrating object should be performed. This is because correct measurement data cannot be recorded due to propagation of vibration of an object to the particle velocity sensor.

Furthermore, when the particle velocity and the sound pressure are recorded, it is desirable to measure a plurality of points at a constant distance from the object surface from the viewpoint of performance improvement, but it is very difficult to simultaneously achieve installation of such a device and vibration insulation. Furthermore, a particle velocity sensor is generally very expensive, and it is disadvantageous in terms of cost to measure a large number of measurement points using a plurality of particle velocity sensors.

Therefore, in the following embodiment, these problems are solved by using the property that the particle velocity in the air can be estimated from the vibration velocity (or vibration acceleration) of the surface of the vibrating object. Specifically, the following embodiment proposes a sensor module that stores both information of sound pressure and particle velocity (specifically, approximate with vibration velocity) of an object by using two micro electro mechanical systems (MEMS: Micro Electro Mechanical Systems) sensor signals arranged close to each other.

### 2. First Embodiment

### [Configuration Example of Sensor Module]

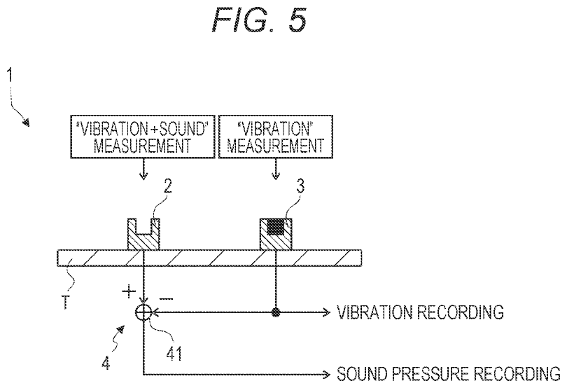

FIG. 5 illustrates a schematic configuration example of a sensor module (a sensor module 1) according to a first embodiment. The sensor module 1 includes a first sensor unit 2, a second sensor unit 3, and a signal processing unit 4. Specifically, the first sensor unit 2 and the second sensor unit 3 are each a measurable MEMS sensor, and are installed at positions close to each other with respect to an object T to be installed. The object T is, for example, a panel-like object (for example, a plate of wood, glass, metal, synthetic resin, or the like) in which vibration can occur. Note that the first sensor unit 2 and the second sensor unit 3 may be configured by a sensor other than the MEMS sensor as long as it is not necessary to reduce the size and weight.

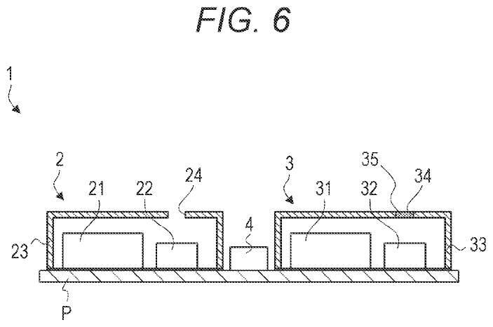

FIG. 6 illustrates a specific configuration example of the sensor module 1. In the present configuration example, the sensor module 1 has a configuration in which the first sensor unit 2, the second sensor unit 3, and the signal processing unit 4 are formed on a substrate P. Specifically, the substrate P is a printed circuit board (PCB: Printed Circuit Board). That is, the sensor module 1 has a configuration in which two MEMS sensors are integrated by the substrate P.

Specifically, the first sensor unit 2 is a MEMS microphone, and includes a transducer 21, an application specific integrated circuit (ASIC) 22, and a housing 23.

The transducer 21 is a converter that converts sound pressure into an electric signal. The transducer 21 is configured by, for example, a capacitive mechanical diaphragm. In this case, specifically, the transducer 21 includes a diaphragm and a back plate arranged with a slight gap therebetween, and outputs, as an electric signal, a change in capacitance due to a change in the gap length caused by vibration of the diaphragm due to sound pressure. The transducer 21 is connected to the ASIC 22, and the electric signal output from the transducer 21 is input to the ASIC 22.

The ASIC 22 is a circuit that generates an output signal output from the first sensor unit 2. The ASIC 22 includes, for example, a charge pump and a preamplifier. The charge pump is a circuit that supplies a bias voltage to the back plate. The electric signal input from the transducer 21 is sent to the preamplifier, subjected to processing such as amplification, and output as an output signal of the first sensor unit 2. The ASIC 22 is connected to the signal processing unit 4, and the output signal output from the first sensor unit 2 is input to the signal processing unit 4.

The housing 23 is a cover member that covers the transducer 21 and the ASIC 22. Specifically, the housing 23 is attached to the substrate P and accommodates the transducer 21 and the ASIC 22 in the internal space. The housing 23 includes, for example, resin, metal, or the like. Note that the housing 23 is provided with a sound hole 24 by machining or the like. The sound hole 24 takes external sound into the housing 23. Note that the shape, position, and number of the sound holes 24 are not limited to those illustrated, and any shape, position, and number may be used. For example, the sound hole 24 may be provided in the substrate P.

Specifically, the second sensor unit 3 is a MEMS sensor, and includes a transducer 31, an ASIC 32, and a housing 33. The transducer 31 and the ASIC 32 are the same as the transducer 21 and the ASIC 22 described above, respectively. The transducer 31 is connected to the ASIC 32, and the electric signal output from the transducer 31 is input to the ASIC 32. The ASIC 32 is connected to the signal processing unit 4, and the output signal output from the second sensor unit 3 (ASIC 32) is input to the signal processing unit 4.

For example, the first sensor unit 2 and the second sensor unit 3 are arranged close to each other at a predetermined interval or less at which detected signals of the first sensor unit 2 and the second sensor unit 3 can be regarded as the same. More specifically, the first sensor unit 2 and the second sensor unit 3 are arranged at positions (intervals) where the vibration of the object T measured by each of the first sensor unit 2 and the second sensor unit 3 falls within a predetermined error range. Since this interval varies depending on the frequency, the interval is appropriately determined according to the recording environment or the like. Specifically, it is sufficient that the interval is an interval at which the processing in the use examples described later can be appropriately performed, and for example, the closer the interval is, the better. Note that, as the first sensor unit 2 and the second sensor unit 3, existing sensors each of which can be used independently may be used, and the existing sensors may be detachably attached to configure the sensor module 1.

The housing 33 is the same as the housing 23 described above, but is different from the housing 23 in that a sound hole 34 is closed by a closing portion 35. The closing portion 35 is formed by closing the sound hole 34 using, for example, a closing material such as an adhesive or a plug member. As described above, in the present embodiment, the normal MEMS microphone (first sensor unit 2) having the sound hole 24 and the MEMS microphone (second sensor unit 3) in which the sound hole 34 is closed are used. Note that the housing 33 may not be provided with the sound hole 34 itself from the beginning. As described above, the second sensor unit 3 has the same structure as the first sensor unit 2 in which the sound hole 34 of the microphone is closed (including a microphone in which the sound hole 34 is not originally provided).

As illustrated in FIG. 5, since both the first sensor unit 2 and the second sensor unit 3 are installed on the object T, vibration information of the object T is detected through housing vibration. Since the sound hole 34 is closed, the diaphragm (specifically, the diaphragm) of the microphone is not shaken by sound wave, and thus the second sensor unit 3 can be used as a device that simply detects the vibration of the object T. Note that, here, in order to make the vibrations of the object T measured by the first sensor unit 2 and the second sensor unit 3 the same, the second sensor unit 3 has the same structure as the first sensor unit 2 except that the sound hole 34 is closed, but may have a different structure as long as the same can be performed. For example, the second sensor unit 3 may include an acceleration sensor.

The signal processing unit 4 is a signal processing circuit that generates an output signal of the sensor module 1. The signal processing unit 4 outputs, as module signals, two signals of a signal of a vibration component of the object T and a signal of a sound pressure component obtained by removing the vibration component of the object T from the output signal of the first sensor unit 2 by using the output signal of the first sensor unit 2 and the output signal of the second sensor unit 3.

Specifically, as illustrated in FIG. 5, the signal processing unit 4 sets the output signal of the second sensor unit 3 as a signal of a vibration component of an object (a vibration recording signal). Furthermore, the signal processing unit 4 sets a signal obtained by subtracting the output signal of the second sensor unit 3 from the output signal of the first sensor unit 2 as a sound pressure component signal (a sound pressure recording signal). More specifically, the signal processing unit 4 includes a subtraction processing unit 41 to which the output signals of the first sensor unit 2 and the second sensor unit 3 are input, and the subtraction processing unit 41 performs subtraction processing of subtracting the input signal (signal of “vibration”) from the second sensor unit 3 from the input signal (signal of “vibration+sound”) from the first sensor unit 2.

Since the first sensor unit 2 and the second sensor unit 3 are sufficiently adjacent to each other, a signal derived from vibration having a high correlation is detected in the first sensor unit 2 and the second sensor unit 3. Therefore, as illustrated in FIG. 5, by performing this subtraction processing on the output signals of both the first sensor unit 2 and the second sensor unit 3, it is possible to separate the vibration-derived component and the sound pressure component. As described above, the signal processing unit 4 performs the subtraction processing on the input signal from each of the first sensor unit 2 and the second sensor unit 3, thereby outputting information on each of the sound pressure and the vibration (vibration velocity).

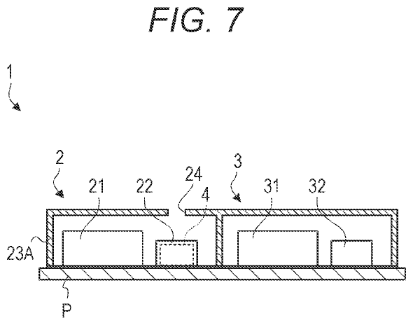

Note that the configuration in which the first sensor unit 2, the second sensor unit 3, and the signal processing unit 4 are incorporated in the sensor module 1 is not limited to that illustrated in FIG. 6. FIG. 7 illustrates another specific configuration example of the sensor module 1. As illustrated in FIG. 7, the signal processing unit 4 may not be arranged between the first sensor unit 2 and the second sensor unit 3. For example, the signal processing unit 4 may be integrally configured with either the ASIC 22 or the ASIC 32. Furthermore, as illustrated in the drawing, the sensor module 1 may have a configuration in which the housing 23A integrated with the first sensor unit 2 and the second sensor unit 3 is used. Furthermore, if both the transducers 21 and 31 are isolated from each other for sound, as illustrated in the drawing, a space may not be provided between the first sensor unit 2 and the second sensor unit 3. Furthermore, the sensor module 1 may include a memory that stores each piece of information of the sound pressure and the vibration (vibration velocity) output from the vibration processing unit 4, a processor that controls the memory, and the like. For example, the sensor module 1 may include a microcomputer. With this configuration, the measurement result can be stored.

### [Operation Example of Sensor Module]

As illustrated in FIG. 5, the sensor module 1 is installed on the object T in a state where the first sensor unit 2 and the second sensor unit 3 are arranged close to each other, and used. The first sensor unit 2 measures sound passing through the sound hole 24 (see FIG. 6) and vibration of the object T. Since the sound hole 34 is closed, the second sensor unit 3 measures only the vibration of the object T. The output signals (measurement signals) of the first sensor unit 2 and the second sensor unit 3 are each input to the signal processing unit 4.

The signal processing unit 4 outputs the measurement signal input from the second sensor unit 3 as a vibration recording signal. Furthermore, the signal processing unit 4 performs signal processing on the measurement signals input from the first sensor unit 2 and the second sensor unit 3, and outputs the signal subjected to the signal processing as a sound pressure recording signal. Specifically, the measurement signals input from the first sensor unit 2 and the second sensor unit 3 are input to the subtraction processing unit 41 of the signal processing unit 4. The subtraction processing unit 41 outputs a difference signal between the measurement signal from the first sensor unit 2 and the measurement signal from the second sensor unit 3. As described above, the sensor module 1 outputs the vibration recording signal and the sound pressure recording signal.

Since the first sensor unit 2 and the second sensor unit 3 are arranged on the surface of the object T, it is possible to measure sound pressure and vibration in a state where a certain distance from the object T is maintained. Furthermore, the approximation of “particle velocity=vibration velocity” holds in the vicinity of the surface of the object T. Therefore, the vibration acceleration (specifically, the integral value of the vibration acceleration) can be substituted as the particle velocity of the object surface. Since the first sensor unit 2 measures the sound pressure and the vibration and the second sensor unit 3 measures the vibration component, the sound pressure and the vibration can be separated by simple signal processing in the signal processing unit 4 as described above.

### Summary

In the present embodiment, the signals of the sound pressure and the vibration acceleration (the differential value of the vibration velocity) can be obtained by performing signal processing on the respective output signals of the first sensor unit 2 and the second sensor unit 3 arranged close to each other. Both the first sensor unit 2 and the second sensor unit 3 are configured by the MEMS sensor, and the MEMS sensor is inexpensively available as an acceleration sensor. Therefore, the cost can be dramatically reduced as compared with the case of using a very expensive particle velocity sensor (for example, 1 million yen/1 ch). In particular, by configuring the first sensor unit 2 with a MEMS microphone and configuring the second sensor unit 3 with a MEMS microphone in which the sound hole 34 is closed (including a case where the sound hole 34 is not provided), the first sensor unit 2 and the second sensor unit 3 can be achieved at low cost (for example, several tens of yen) as compared with a case where an expensive piezoelectric acceleration sensor (for example, 80,000 yen/1 ch) or the like is used. Therefore, the sound pressure and the particle velocity (vibration velocity) in the vicinity of the surface of the object T can be measured with an inexpensive device.

Furthermore, by recording the acceleration of the object T as described above, measurement on the surface can be uniformly performed. As a result, it possible to suppress variation in the distance from the object surface, which is a problem that occurs when the particle velocity sensor is used. That is, by installing the first sensor unit 2 and the second sensor unit 3 on the surface of the object T and using the vibration velocity of the object surface, it is possible to suppress the variation in the distance from the surface, which is a problem in the case of using the particle velocity sensor, which occurs as an installation error for each device.

Furthermore, since the vibration component (the measurement signal of “vibration” in the second sensor unit 3) is subtracted from the measurement signal of “sound pressure+vibration” in the first sensor unit 2 at the time of recording the sound pressure as signal processing, the isolation between the sound pressure component and the vibration component can be increased.

Furthermore, the sound pressure value and the vibration velocity can be calculated by signal processing. As a result, it becomes possible to calculate a physical quantity necessary for noise control in space. Specifically, it is possible to measure acoustic radiation power necessary for controlling the vibration-derived noise radiated from the object. As described above, the active control can be easily performed at low cost.

### 3. Second Embodiment

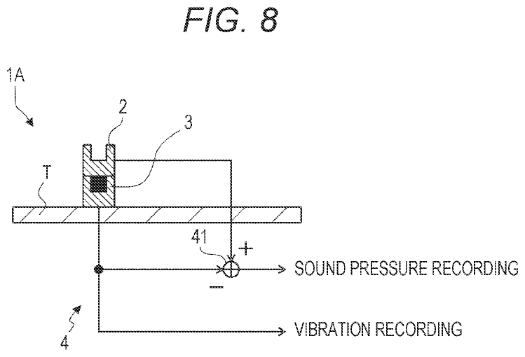

FIG. 8 illustrates a schematic configuration example of a sensor module (a sensor module 1A) according to a second embodiment. The sensor module 1A includes a first sensor unit 2, a second sensor unit 3, and a signal processing unit 4. The sensor module 1A is different from the sensor module 1 of the first embodiment in the arrangement of the first sensor unit 2 and the second sensor unit 3. The other points are the same as those of the first embodiment.

In the sensor module 1A according to the present embodiment, the first sensor unit 2 and the second sensor unit 3 are arranged close to each other by arranging the first sensor unit 2 on the second sensor unit 3 arranged on the surface of the object T. That is, the sensor module 1A has a structure in which the second sensor unit 3 and the first sensor unit 2 are sequentially stacked and installed on the object T. As described above, the first sensor unit 2 and the second sensor unit 3 are not limited to be arranged in the direction along the surface of the object T, and may be arranged close to each other in the direction orthogonal to the surface of the object T. Furthermore, the first sensor unit 2 and the second sensor unit 3 may not be directly installed on the surface of the object T.

Note that, although not illustrated here, the first sensor unit 2 and the second sensor unit 3 may be each installed on a different surface of the object T. In this case, the first sensor unit 2 is installed on the surface on the space side where sound needs to be measured. Note that, in this case, since vibration having a phase opposite to that in the case of being installed on the same surface as the first sensor unit 2 is measured from the second sensor unit 3, it is necessary to match the phases.

In this manner, the first sensor unit 2 and the second sensor unit 3 is only required to be arranged close to each other. The first sensor unit 2 is only required to be arranged in a state where the sound through the sound hole 24 and the vibration of the object T can be measured. The second sensor unit 3 is only required to be arranged in a state where the vibration of the object T can be measured. Since the first sensor unit 2 and the second sensor unit 3 are arranged close to each other, a signal derived from vibration having a high correlation is measured in each of the sensor units, so that it is possible to realize an operation similar to that of the sensor module 1 according to the first embodiment.

As described above, in the present embodiment, similarly to the first embodiment, the signals of the sound pressure and the vibration acceleration can be obtained by performing signal processing on the output signals of the first sensor unit 2 and the second sensor unit 3 arranged close to each other. Therefore, the same effects as those of the first embodiment described above are obtained. Specifically, the active control can be easily performed at low cost.

Furthermore, since the first sensor unit 2 and the second sensor unit 3 measure the vibration of the object T at the same place, each of the first sensor unit 2 and the second sensor unit 3 can measure a signal derived from vibration having a higher correlation, and the isolation between the sound pressure component and the vibration component can be further increased.

Furthermore, since the first sensor unit 2 is arranged in the second sensor unit 3 installed on the surface of the object T, the installation area for the object T can be reduced.

### 4. Third Embodiment

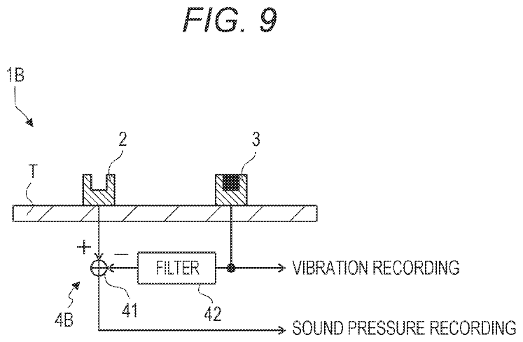

FIG. 9 illustrates a schematic configuration example of a sensor module (a sensor module 1B) according to a third embodiment. The sensor module 1B includes a first sensor unit 2, a second sensor unit 3, and a signal processing unit 4B. The signal processing unit 4B is different from the signal processing unit 4 described in the first embodiment in that the signal processing unit 4B includes a filter processing unit 42. Hereinafter, differences from the first embodiment will be described.

The signal processing unit 4B includes a subtraction processing unit 41 and the filter processing unit 42. The filter processing unit 42 absorbs a difference in vibration detection characteristics between the first sensor unit 2 and the second sensor unit 3. That is, the filter processing unit 42 corrects the vibration component. Specifically, the filter processing unit 42 is provided between the second sensor unit 3 and the subtraction processing unit 41.

As a result of closing the sound hole 34 (see FIG. 6), in the second sensor unit 3, the sensitivity of vibration transmission in the MEMS sensor may change as compared with the case where the sound hole 34 is present. The filter processing unit 42 performs, for example, difference absorption processing of absorbing a difference due to this change with a correction filter. The measurement signal (vibration component) processed by the filter processing unit 42 is output to the subtraction processing unit 41. That is, the subtraction processing unit 41 performs subtraction using the output signal (specifically, the output signal of the second sensor unit 3) in which the difference has been absorbed by the filter processing unit 42. The other points (configuration, operation, and the like) are as described in the first embodiment.

As described above, in the present embodiment, similarly to the first embodiment, the signals of the sound pressure and the vibration acceleration can be obtained by performing signal processing on the output signals of the first sensor unit 2 and the second sensor unit 3 arranged close to each other. Therefore, the same effects as those of the first embodiment described above are obtained. Specifically, the active control can be easily performed at low cost.

Furthermore, since the difference in change in vibration recording characteristics due to the closing of the sound hole 34 (see FIG. 5) is corrected by including the filter processing unit 42, it is possible to prevent the sound pressure components from not being appropriately recorded due to the change in the vibration recording characteristics due to the closing of the sound hole 34.

### 5. Fourth Embodiment

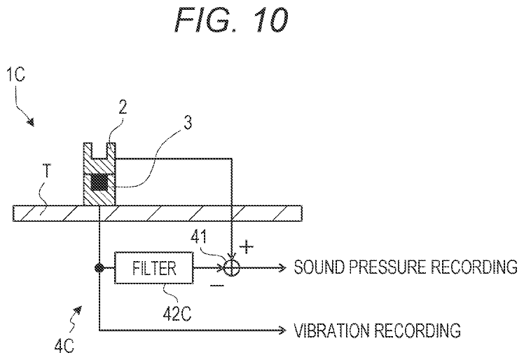

FIG. 10 illustrates a schematic configuration example of a sensor module (a sensor module 1C) according to a fourth embodiment. The sensor module 1C includes a first sensor unit 2, a second sensor unit 3, and a signal processing unit 4C. The signal processing unit 4C is different from the signal processing unit 4 of the second embodiment in that the signal processing unit 4C includes a filter processing unit 42C. Hereinafter, differences from the second embodiment will be described.

The signal processing unit 4C includes a subtraction processing unit 41 and the filter processing unit 42C. The filter processing unit 42C absorbs a difference in vibration detection characteristics between the first sensor unit 2 and the second sensor unit 3, and is provided between the second sensor unit 3 and the subtraction processing unit 41.

The filter processing unit 42C performs difference absorption processing similar to that of the filter processing unit 42 described above with the correction filter. Furthermore, the vibration measured by the first sensor unit 2 is caused by vibration attenuation in the second sensor unit 3. Therefore, the filter processing unit 42C also performs difference absorption processing of absorbing a difference in the vibration recording characteristics between the first sensor unit 2 and the second sensor unit 3 with the correction filter. Note that the absorption of the difference with the correction filter is not limited thereto. For example, in a case where the first sensor unit 2 and the second sensor unit 3 are not arranged sufficiently close to each other, the measurement signals of the first sensor unit 2 and the second sensor unit 3 may not be regarded as the same. In this case, the filter processing unit 42C may be used as a unit that absorbs the difference with the correction filter and performs correction such that the difference can be regarded as the same. The same applies to the filter processing unit 42 of the third embodiment described above.

The measurement signal (vibration component) processed by the filter processing unit 42C is output to the subtraction processing unit 41. Note that, in the illustrated example, the signal processing unit 4C outputs the output signal of the second sensor unit 3 as the vibration recording signal, but may output the signal processed by the filter processing unit 42C as the vibration recording signal. The same applies to the signal processing unit 4B of the third embodiment. The other points (configuration, operation, and the like) are as described in the second embodiment.

As described above, in the present embodiment, similarly to the second embodiment, the signals of the sound pressure and the vibration acceleration can be obtained by performing signal processing on the output signals of the first sensor unit 2 and the second sensor unit 3 arranged close to each other. Therefore, the same effects as those of the second embodiment described above are obtained. Specifically, the active control can be easily performed at low cost.

Furthermore, by including the filter processing unit 42C, a difference in change in the vibration recording characteristics due to closing of the sound hole 34 (see FIG. 5), a difference in change in the vibration recording characteristics due to installation of the first sensor unit 2 on the object T via the second sensor unit 3, and the like are corrected, so that it is possible to prevent the sound pressure components from not being appropriately recorded due to these changes in the vibration recording characteristics.

### 6. Fifth Embodiment

In each of the above-described embodiments, the example of separating the vibration component and the sound pressure component using simple arithmetic processing is described. However, the gist of the present disclosure includes separating useful components using devices arranged close to each other having different recording ratios of the sound pressure and the vibration velocity. Therefore, more general-purpose signal processing may be performed in implementation as described below.

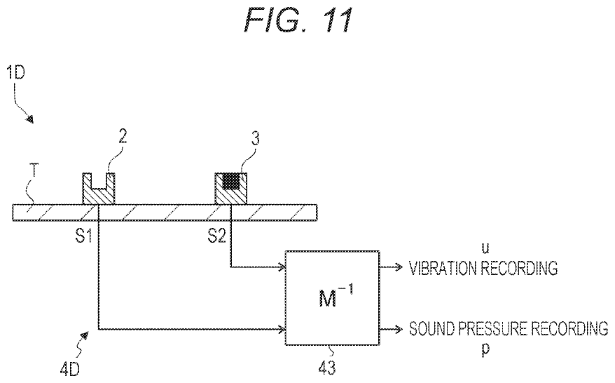

FIG. 11 illustrates a schematic configuration example of a sensor module (a sensor module 1D) according to a fifth embodiment. The sensor module 1D includes a first sensor unit 2, a second sensor unit 3, and a signal processing unit 4D. The first sensor unit 2 and the second sensor unit 3 are arranged in the same manner as the sensor module 1 according to the first embodiment. The output signals of the first sensor unit 2 and the second sensor unit 3 are each input to the signal processing unit 4D.

The signal processing unit 4D includes a correction processing unit 43 that corrects the output signal of the first sensor unit 2 and the output signal of the second sensor unit 3 according to the recording ratio of the vibration due to the sound pressure in the second sensor unit 3. For example, the correction processing unit 43 includes a correction circuit that performs correction by generalized signal processing. Specifically, the correction processing unit 43 performs predetermined calculation processing on the output signals S1 and S2 of the first sensor unit 2 and the second sensor unit 3 to generate the corrected vibration recording signal u and sound pressure recording signal p. For example, the correction processing unit 43 performs correction by generalized signal processing using the following Expression (1).

$$\begin{matrix}[ Math . 1 ] & \\ [ \begin{matrix}S 1 \\ S 2\end{matrix} ] = \underbrace{[ \begin{matrix}a & b \\ c & d\end{matrix} ]}_{M} [ \begin{matrix}p \\ u\end{matrix} ] & ( 1 )\end{matrix}$$

Elements a and b of the transformation matrix M are recording ratios of sound and vibration of the output signal S1, and elements c and d are recording ratios of sound and vibration of the output signal S2. Each element is appropriately adjusted so as to obtain the vibration recording signal u and the sound pressure recording signal p corrected as desired, and these can be defined in advance. For example, the case of the first embodiment described above corresponds to a case where “a=0” and “b=d” are defined. Furthermore, the cases of the third embodiment and the fourth embodiment correspond to the cases of “a=0” and “b≠d”.

For example, the correction processing unit 43 calculates the vibration recording signal u and the sound pressure recording signal p by executing the inverse matrix calculation of Expression (1). That is, the vibration recording signal u and the sound pressure recording signal p can be obtained by the following Expression (2).

$$\begin{matrix}[ Math . 2 ] & \\ [ \begin{matrix}p \\ u\end{matrix} ] = {M}^{- 1} [ \begin{matrix}S 1 \\ S 2\end{matrix} ] & ( 2 )\end{matrix}$$

Certainly, in order to clearly calculate acoustic intensity as in Non-Patent Document 2 described above, it is necessary to perform calculation by decomposing the output signals into the acoustic intensity into the sound pressure and the particle velocity (or the vibration velocity). However, in the case of using only for sound pressure estimation at a distant position as in Non-Patent Document 1, it is not necessary to clearly decompose the output signals into the sound pressure and the particle velocity. Furthermore, even in a case where active control is performed using a signal processing block such as a deep neural network (DNN) in which output information can be estimated from input information by learning, it is not necessary to clearly separate sound pressure and particle velocity components. Therefore, the signal processing unit 4D may include a correction circuit that performs processing including such a generalized form.

As described above, in the present embodiment, similarly to the first embodiment, the signals of the sound pressure and the vibration acceleration can be obtained by performing signal processing on the output signals of the first sensor unit 2 and the second sensor unit 3 arranged close to each other. Therefore, the same effects as those of the first embodiment described above are obtained. Specifically, the active control can be easily performed at low cost.

Furthermore, useful components can be appropriately separated by including the correction processing unit 43. For example, it is possible to check in advance how much each of the components of sound and vibration is included in the output signals of the first sensor unit 2 and the second sensor unit 3, and to perform correction with the settings corresponding thereto. Specifically, in a case where the output signal of the second sensor unit 3 includes a sound pressure component, filtering can be performed so as to remove the component.

### 7. First Use Example of Sensor Module

In the present use example, active control (specifically, active noise control) is performed using the sensor module 1 described above. The active control in the present use example is achieved through three stages of a recording phase, an analysis phase, and an operation phase. The second use example described later is also the same. Hereinafter, each stage will be described in detail. Note that, in the present use example, a case where the sensor module 1 according to the first embodiment is applied will be described as an example, but a sensor module (for example, the sensor module 1A and the like) of another embodiment or the like may be applied. The same applies to other use examples described later.

### [System Configuration Example of Recording Phase]

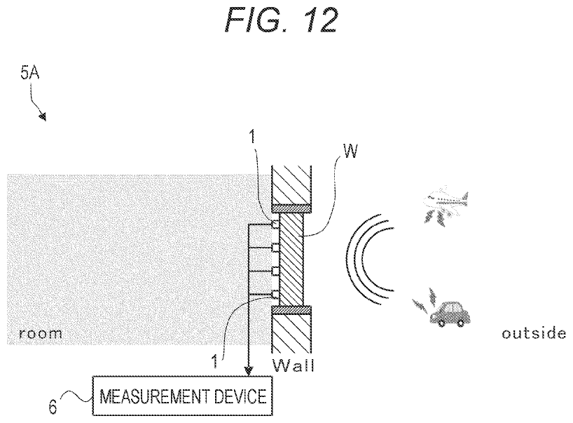

FIG. 12 illustrates a configuration example of a system (a measurement system 5A) in the recording phase. In the present use example (the same applies to the second use example described later), an environment is assumed in which noise (for example, traffic noise and the like) generated outdoors enters a room via a window. The entering noise is radiated indoors as vibration-derived noise as a result of acoustic excitation of a window glass W. In this manner, a case where the window glass W is actively controlled as a control target will be described as an example. Note that the control target may be other than the window glass W.

The measurement system 5A includes a sensor module 1 and a measurement device 6. The sensor module 1 is installed in an actual space (indoor in the present example) in which active control is performed. In the present example, the sensor module 1 is attached to the indoor-side surface of the window glass W. That is, the window glass W corresponds to the above-described object T.

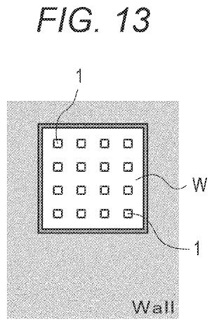

FIG. 13 illustrates an installation example of the sensor module 1. A plurality of sensor modules 1 is attached to the window glass W. For example, in the example illustrated, 16 sensor modules 1 are arranged at equal intervals. Note that the number and arrangement of the sensor modules 1 may be other than those illustrated. Each sensor module 1 outputs a module signal (the sound pressure recording signal and the vibration recording signal described above).

As illustrated in FIG. 12, each sensor module 1 is connected to the measurement device 6. This connection is not limited to a specific connection, and may be a wired connection or a wireless connection. The measurement device 6 is an information processing device (for example, a personal computer) that functions as a computer. The measurement device 6 records (for example, stores in the storage area) the module signal input from each sensor module 1. Note that, specifically, the module signals of the sensor modules 1 are recorded in a synchronized state at the same time.

### [System Configuration Example of Analysis Phase]

In the analysis phase, the measurement device 6 used in the recording phase is used as an analysis device. Note that an information processing device other than the measurement device 6 may be used as the analysis device in the analysis phase as long as the module signal recorded in the recording phase can be used.

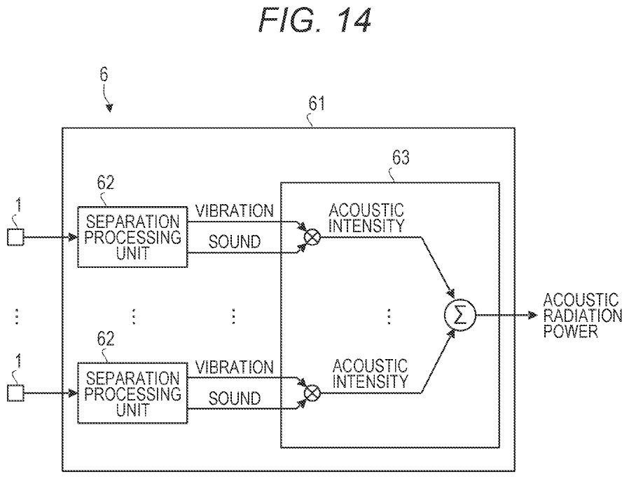

FIG. 14 is a functional block diagram illustrating a configuration example of the measurement device 6. In the analysis phase, the measurement device 6 analyzes the measurement signal using the recorded module signal. Specifically, the measurement device 6 includes a sensor analysis unit 61 that analyzes the measurement signal. The sensor analysis unit 61 includes separation processing units 62 and an analysis processing unit 63. The separation processing unit 62 is a block that separates the sensor module signal into a vibration component and a sound component, and is provided corresponding to each sensor module 1. The vibration component and the sound component separated by each separation processing unit 62 are input to the analysis processing unit 63.

The analysis processing unit 63 is a block that analyzes the coupling between vibration and sound to estimate power (acoustic radiation power) radiated from the window glass W. The analysis processing unit 63 calculates acoustic intensity by “sound pressure×particle velocity (vibration velocity)” with an arithmetic circuit by using the vibration component and the sound component of each sensor module 1 input from each separation processing unit 63. Then, the analysis processing unit 63 calculates the sum of the respective acoustic intensities, estimates the calculation result as acoustic radiation power, and outputs (for example, stores in a storage medium) the acoustic radiation power.

Here, in the analysis processing, the acoustic radiation power can be accurately estimated by arranging as many sensor modules 1 as possible. However, at the time of actual operation, a case where it is necessary to narrow down the number of sensors due to restriction on design arrangement, device cost, and the like is conceivable.

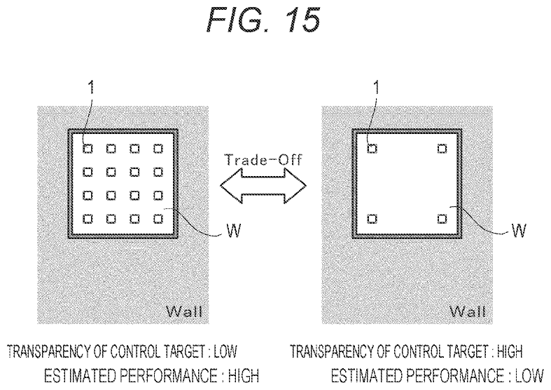

FIG. 15 illustrates features due to a difference in the number of sensor modules 1. As illustrated in FIG. 15, a trade-off relationship is established between the number of sensor modules 1 and the estimation performance. Specifically, if the number of the sensor modules 1 is increased, the appearance is impaired, for example the transparency is lowered, but the estimation performance of the acoustic radiation power is improved. On the other hand, if the number of the sensor modules 1 is decreased, the appearance is improved, for example, the transparency is increased, but the estimation performance of the acoustic radiation power is lowered. Since the user can predict (specifically, prediction by acoustic radiation power) the estimated performance of the active control through the sensor analysis unit 61 from the sensor position appropriately selected at the time of recording, it is possible to narrow down the sensor position corresponding to the application.

### [System Configuration Example During Operation]

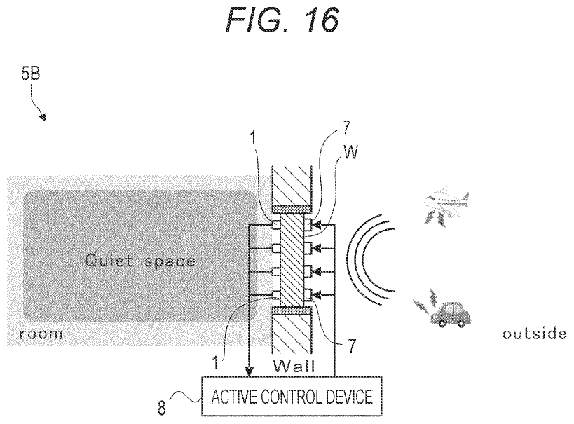

In the operation phase, actuators actually used for active control are arranged, and active control processing is performed in real time. FIG. 16 illustrates a configuration example of a system (an active control system 5B) in the operation phase. The active control system 5B includes a sensor module 1, an actuator 7, and an active control device 8.

The sensor module 1 is different from that at the time of measurement and analysis in that the sensor module 1 is connected not to the analysis device (measurement device 6) used at the time of analysis but to the active control device 8. This is because it is necessary to connect a dedicated active controllable signal processing device in which a low delay is secured at the time of operation. The other points (for example, the configuration, arrangement, and the like) are the same as those at the time of measurement and analysis. Note that the measurement device 6 may be used if there is no problem in terms of processing, for example in a case where a low delay is secured.

The actuator 7 excites vibration on the glass surface of the window glass W. As the actuator 7, for example, an exciter installed on a glass surface and used can be used. Note that the actuator 7 may be any type as long as the actuator excites vibration.

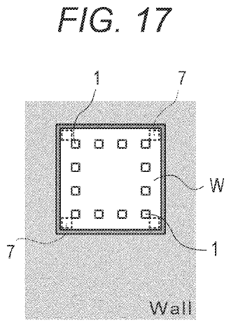

FIG. 17 illustrates a setting example of the device. The sensor module 1 is installed on the indoor-side surface of the window glass W in the same manner as in the measurement. Note that the sensor module 1 is installed leaving only the module selected in the previous phase. Each sensor module 1 outputs the module signal described above.

The actuator 7 is installed on the outdoor-side surface of the window glass W. In the illustrated example, the actuators 7 are installed at four corners of the window glass W one by one. Note that the number and arrangement of the actuators 7 are not limited to those illustrated in the drawings. For example, the actuator 7 may be installed on the indoor-side surface, which is the same as the sensor module 1. Each actuator 7 operates to excite vibration in the window glass W. Each sensor module 1 and each actuator 7 are connected to the active control device 8. This connection may be a wired connection or a wireless connection as long as the active control processing is not hindered.

The active control device 8 is an information processing device that functions as a computer. As described above, the active control device 8 is configured by, for example, a dedicated device that ensures a low delay that does not hinder the active control processing.

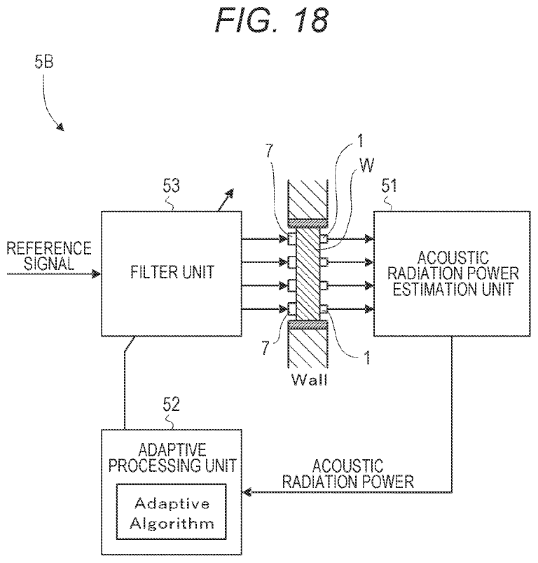

FIG. 18 is a functional block diagram illustrating a configuration example of the active control system 5B. Note that, although a feedforward control method will be described here, the case of a feedback control method is essentially the same. The same applies to other use examples.

The active control system 5B includes an acoustic radiation power estimation unit 51, an adaptive processing unit 52, and a filter unit 53 as functional blocks. For example, the active control device 8 described above includes the acoustic radiation power estimation unit 51 and the adaptive processing unit 52, and the control module including the actuator 7 includes the filter unit 53. Note that a module or a device having each unit, and connections between modules or devices can be appropriately changed as long as the following operation (processing) can be executed.

The acoustic radiation power estimation unit 51 inputs a module signal of each sensor module 1 and estimate acoustic radiation power. Specifically, the acoustic radiation power estimation unit 51 generates acoustic radiation power in the same manner as the sensor analysis unit 61 in the analysis phase. The acoustic radiation power estimated by the acoustic radiation power estimation unit 51 is output to the adaptive processing unit 52.

The adaptive processing unit 52 performs an adaptive processing using an adaptive algorithm (Adaptive Algorithm) and design a control filter (an adaptive filter). In the adaptive processing, calculation is performed so that the entire system is optimized. In the present use example, the adaptive processing is operated so as to minimize the acoustic radiation power. That is, acoustic radiation due to vibration is effectively eliminated by equalizing suction and discharge described in FIG. 3. In the illustrated example, the control filter of the filter unit 53 is designed so that the operation of each actuator 7 is optimized. Specifically, the adaptive processing unit 52 outputs the filter coefficients of the control filter to the filter unit 53.

The filter unit 53 performs filtering using the control filter designed by the adaptive processing unit 52. A reference signal output from a reference sensor (for example, a microphone and an acceleration sensor) that detects a reference signal in the active control is input to the filter unit 53. This reference microphone may be separately provided, or any one of the sensor modules 1 may be used as a reference microphone. The filter unit 53 filters the input reference signal and generates a drive signal for each actuator 7. The generated drive signal is output to the corresponding actuator 7, and each actuator 7 is driven.

### [Example Flow of Active Control Processing]

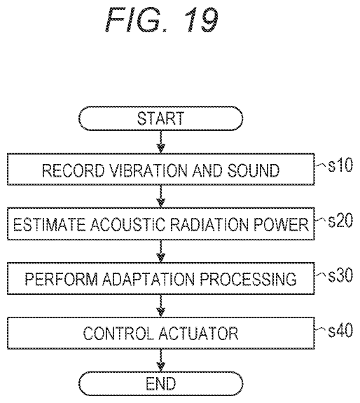

FIG. 19 is a flowchart illustrating a flow of active control processing in the active control system 5B. In the active control processing, first, the active control device 8 records vibration and sound (step S10). Specifically, the active control device 8 records module signals (a vibration recording signal and a sound pressure recording signal) output from the sensor module 1. Next, the active control device 8 estimates acoustic radiation power (step S20). Specifically, the acoustic radiation power estimation unit 51 calculates each acoustic intensity from the corresponding module signal, and estimates the entire acoustic radiation power using the calculation result.

Next, the active control device 8 executes an adaptive processing (step S30). Specifically, the adaptive processing unit 52 performs the adaptive processing by using the acoustic radiation power estimated by the acoustic radiation power estimation unit 51 so as to minimize the acoustic radiation power. That is, a control filter for filtering the reference signal in the active control is designed (filter coefficients are calculated).

Then, the reference signal is filtered by the designed control filter, and each actuator 7 is controlled (step S40). By controlling each actuator 7 in this manner, the acoustic radiation power radiated from the window glass W is minimized, and it is possible to reduce noise in the entire space.

### [Hardware Configuration Example of Information Processing Device]

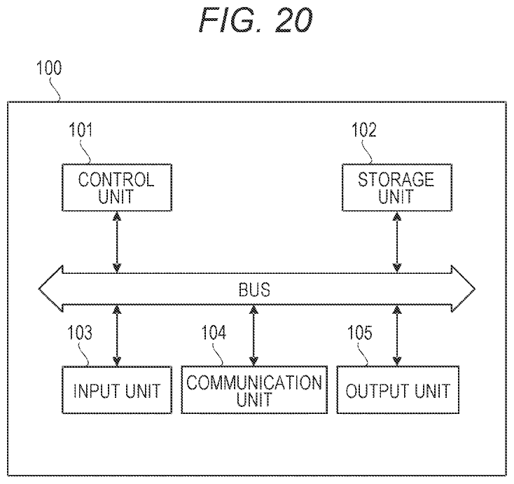

FIG. 20 illustrates a hardware configuration example of an information processing device (an information processing device 100) that can be adopted in the measurement device 6, the active control device 8, and the like described above. The information processing device 100 includes a control unit 101, a storage unit 102, an input unit 103, a communication unit 104, and an output unit 105, which are coupled to each other by a bus.

The control unit 101 includes, for example, a central processing unit (CPU), a random access memory (RAM), a read only memory (ROM), and the like. The ROM stores programs to be read and operated by the CPU, and the like. The RAM is used as a work memory of the CPU. The CPU controls the entire information processing device 100 by executing various processes according to a program stored in the ROM and issuing commands.

The storage unit 102 is a storage medium including, for example, a hard disk drive (HDD), a solid state drive (SSD), a semiconductor memory, or the like, and stores data such as a program (for example, application) in addition to content data such as image data, video data, audio data, and text data.

The input unit 103 is a device for inputting various types of information to the information processing device 100. When the input unit 103 inputs information, the control unit 101 performs various types of processing according to the input information. The input unit 103 may be, in addition to a mouse and a keyboard, a microphone, various sensors, a touch panel, a touch screen integrally configured with a monitor, a physical button, or the like. Note that the various types of information may be input to the information processing device 100 via the communication unit 104 to be described later.

The communication unit 104 is a communication module that communicates with other devices and the Internet according to a predetermined communication standard. Examples of a communication scheme include a wireless local area network (LAN) such as Wireless Fidelity (Wi-Fi), Long Term Evolution (LTE), 5th generation mobile communication system (5G), broadband, Bluetooth (registered trademark), and the like.

The output unit 105 is a device for outputting various types of information from the information processing device 100. The output unit 105 includes, for example, an output device such as a display that displays an image or a video or a speaker. Note that the various types of information may be output from the information processing device 100 via the communication unit 104.

The control unit 101 performs various types of processing by, for example, reading and executing a program (for example, application) stored in the storage unit 102. That is, the information processing device 100 has a function as a computer.

Note that the program (for example, application) may not be stored in the storage unit 102. For example, a program stored in a storage medium readable by the information processing device 100 may be read and executed. Examples of the storage medium include an optical disk, a magnetic disk, a semiconductor memory, an HDD detachable from the information processing device 100, and the like. Furthermore, a program (for example, application) or data may be stored in a device (for example, cloud storage) connected to a network such as the Internet, and the information processing device 100 may read the program or data therefrom to execute the program.

### Summary

As described above, in the present use example, the active control can be easily performed at low cost by using the sensor module 1 as described above. The entire space can be controlled by estimating the acoustic radiation power using the module signal recorded in the sensor module 1 and performing the adaptive processing so as to minimize the acoustic radiation power. Since the entire space can be controlled, an error microphone is unnecessary. Moreover, since acoustic radiation due to vibration is eliminated by minimizing the acoustic radiation power, the active control can be efficiently performed.

### 8. Second Use Example of Sensor Module

In the first use example described above, the acoustic radiation power is estimated to control the sound of the entire space, but in the present use example, an error signal at a specific position is estimated to control sound at the specific position.

### [System Configuration Example of Recording Phase]

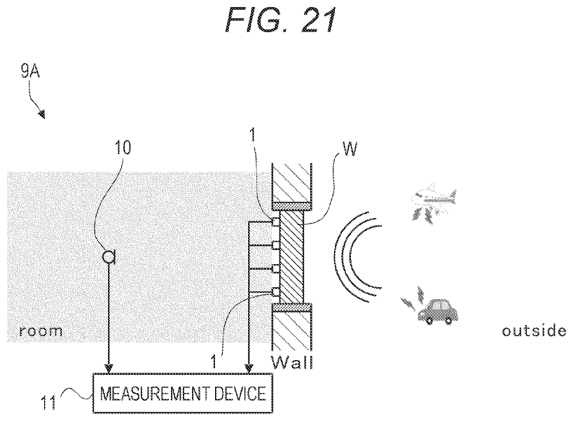

FIG. 21 illustrates a configuration example of a system (a measurement system 9A) in the recording phase. The measurement system 9A includes a sensor module 1, a microphone 10, and a measurement device 11. The configuration and arrangement of the sensor module 1 are as described in the first use example, and each sensor module 1 outputs a module signal.

Similarly to the sensor module 1, the microphone 10 is installed in an actual space (indoor in the present example) in which active control is performed. The microphone 10 is an error microphone in active control, is installed at a specific indoor location serving as a control point, and outputs sound of the control point as an error signal. Each sensor module 1 and the microphone 10 are connected to the measurement device 11. This connection may be a wired connection or a wireless connection.

The measurement device 11 includes an information processing device (for example, a personal computer) that functions as a computer. The measurement device 11 records (for example, stores in the storage area) a module signal input from each sensor module 1 and an error signal input from the microphone 10. Specifically, each module signals and the error signal are recorded in a synchronized state at the same time.

### [System Configuration Example of Analysis Phase]

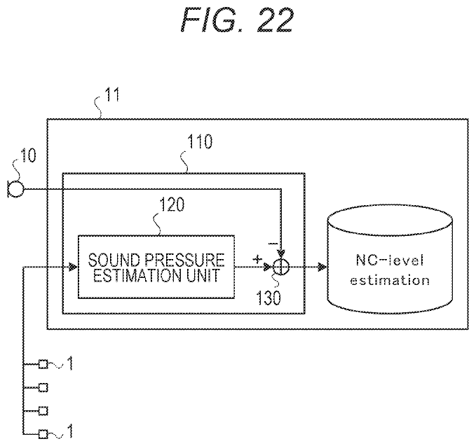

In the analysis phase, the measurement device 11 used in the recording phase is used. Note that, as described in the first use example, another information processing device other than the measurement device 11 may be used. FIG. 22 is a functional block diagram illustrating a configuration example of the measurement device 11. In the analysis phase, the measurement device 11 analyzes these measurement signal using the recorded module signal and the error signal. Specifically, the measurement device 11 includes a sensor analysis unit 110 that performs this analysis.

The sensor analysis unit 110 includes a sound pressure estimation unit 120 and an arithmetic processing unit 130, and evaluates sound pressure estimation performance at an installation position of the microphone 10. The sound pressure estimation unit 120 estimates the sound pressure (estimation error signal) at the installation position of the microphone 10. This corresponds to the sound pressure estimation at the headrest position in Non-Patent Document 1 described above. Specifically, the sound pressure estimation unit 120 receives the module signal of each sensor module 1 as an input, and performs learning using the measurement signal so as to minimize a square error with the error signal of the microphone 10. At the time of this learning, for example, the linear equation may be directly solved by assuming linearity, or the linear equation may be solved on the basis of machine learning using error back propagation by a neural network. As described above, the estimation algorithm used by the sound pressure estimation unit 120 is not limited to a specific algorithm as long as the sound pressure at the installation position of the microphone 10 can be estimated. Note that the acoustic radiation power in the first use example described above may also be estimated using these estimation algorithms.

The sound pressure estimated by the sound pressure estimation unit 120 is output to the arithmetic processing unit 130. The arithmetic processing unit 130 calculates a difference between the sound pressure (estimation error signal) input from the sound pressure estimation unit 120 and the sound pressure (error signal) input from the microphone 10, and outputs the calculation result as estimation performance (NC-level estimation) of the sound pressure. The estimation performance of the sound pressure obtained as a result of this analysis is directly linked to noise reduction performance in the active control. The sensor analysis unit 110 outputs (for example, stores in a storage medium) the estimation performance output from the arithmetic processing unit 130 as the upper limit performance of the active control.

Note that, in the analysis processing of the present use example, the upper limit performance of the active control can be estimated more accurately by arranging a large number of sensor modules 1 and estimating the noise suppression performance. However, the number of sensors may need to be narrowed down. Since the user can predict the estimated limit performance of the active control through the sensor analysis unit 110 from the sensor position selected at the time of recording, it is possible to narrow down the sensor position corresponding to the application.

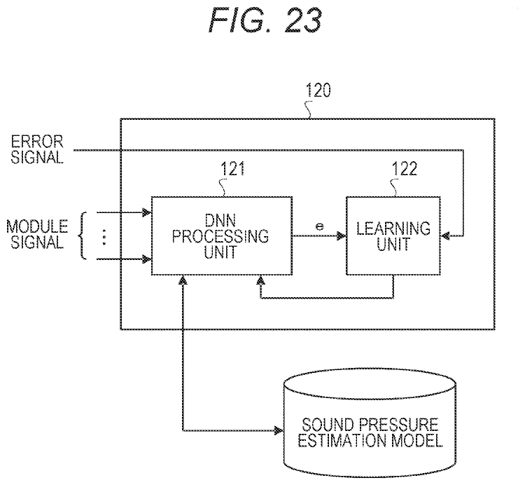

Here, an estimation example of the estimation error signal using the above-described machine learning will be described. FIG. 23 is a functional block diagram illustrating a configuration example of the sound pressure estimation unit 120 in a case where machine learning is used. In the present example, the sound pressure estimation unit 120 generates a sound pressure estimation model for estimating the sound pressure at the position of the error microphone (the microphone 10) by learning using the limit performance (NC-level estimation) as an objective function.

In this case, the sound pressure estimation unit 120 can include, for example, a learning processor. Specifically, the sound pressure estimation unit 120 includes a DNN processing unit 121 and a learning unit 122. The DNN processing unit 121 includes, for example, a deep neural network. The DNN processing unit 121 receives the module signal of each sensor module 1 as an input, and generates an estimation error signal e (estimated sound pressure at the position of the microphone 10) to be output to the learning unit 122. The learning unit 122 uses the estimation error signal e and an error signal Perr of the microphone 10 as inputs, and performs learning by back propagation so as to minimize the objective function (NC-level estimation) by the following Expression (3), for example.

$$\begin{matrix}[ Math . 3 ] & \\ NC - level estimation = 20 {log}_{10} ( \frac{e}{Perr} ) & ( 3 )\end{matrix}$$

That is, the learned model (sound pressure estimation model) is generated by performing training so as to correct the weight of the deep neural network such that the difference between the estimation error signal e estimated from the module signal of each sensor module 1 and the error signal perr is minimized. The sound pressure estimation model obtained In this manner is stored to be available. Specifically, the DNN processing unit 121 stores the learned sound pressure estimation model in the storage area in association with the selected sensor module 1 (sensor module group). As described above, the estimation error signal e can be estimated from the module signal of each sensor module 1.

Note that since ideal limit performance is in the state of “estimation error signal=0”, the limit performance (NC-level estimation) that can be achieved by the present system is equivalent to the estimation error in which an error signal is estimated from the module signal of each sensor module 1. Therefore, the energy ratio between the estimation error signal e and the error signal Perr may be used as an estimation value of the NC performance.

### [System Configuration Example During Operation]

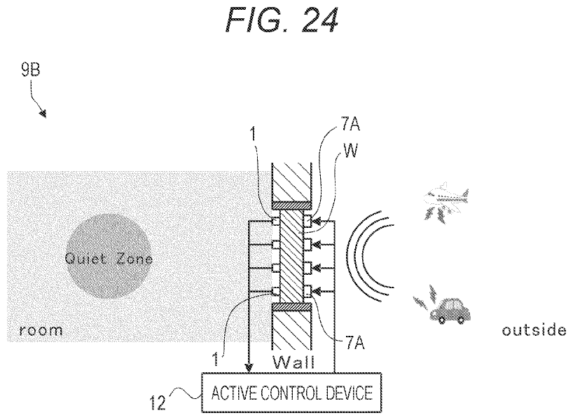

In the operation phase, an actuator for control is actually arranged, and the active control processing is performed in real time. FIG. 24 illustrates a configuration example of a system (an active control system 9B) in the operation phase. The active control system 9B includes a sensor module 1, an actuator 7A, and an active control device 12. That is, in the operation phase, there is no problem with removing the microphone 10 installed in the recording phase. As described above, this is because the filter, which maximizes the estimation performance of the microphone 10 (error microphone) from the sensor module 1, has already been calculated by the sound pressure estimation unit 120 in the analysis phase.

The sensor module 1 is connected not to the analysis device (the measurement device 11) used at the time of analysis but to the active control device 12. The other points (for example, the configuration, arrangement, and the like) are the same as those at the time of analysis (at the time of measurement). Note that, as in the case of the first use example, the measurement device 11 may be used as long as a low delay is secured.

The actuator 7A controls sound at a place where the microphone 10 is installed. As the actuator 7A, for example, the same actuator (the configuration, number, arrangement, and the like) as the actuator 7 described in the first use example can be adopted. Note that, in the present use example, since it is sufficient to be able to control sound at a specific position, the actuator 7A is not limited to a device to which vibration is added, and a speaker (for example, a transparent speaker device) or the like that directly excites sound may be used. In this case, the arrangement place, number, and the like can be appropriately selected.

Each sensor module 1 and each actuator 7A are connected to the active control device 12. This connection may be a wired connection or a wireless connection as long as the active control processing is not hindered.

The active control device 12 is an information processing device that functions as a computer. The active control device 12 is configured by, for example, a dedicated device that ensures a low delay that does not hinder the active control processing.

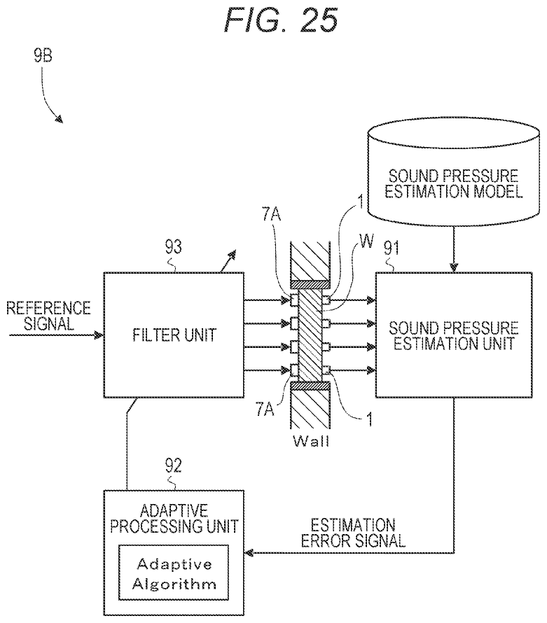

FIG. 25 is a functional block diagram illustrating a configuration example of the active control system 9B. The active control system 5B includes a sound pressure estimation unit 91, an adaptive processing unit 92, and a filter unit 93 as functional blocks. For example, the active control device 12 includes the sound pressure estimation unit 91 and the adaptive processing unit 92, and the control module including the actuator 7A includes the filter unit 93. Note that a module or a device having each unit, and connections between modules or devices can be appropriately changed as long as the following operation (processing) can be executed.

The sound pressure estimation unit 91 is a processing block designed using “NC-level estimation” in the analysis phase. That is, the sound pressure estimation unit 91 receives the module signal of each sensor module 1 as input, and estimates and outputs the estimation error signal using the estimation algorithm. For this estimation, for example, the learned sound pressure estimation model described above is used. The sound pressure estimation unit 91 selects a “sound pressure estimation model” corresponding to the selected sensor module 1 (sensor module group) and generates an estimation error signal. The generated estimation error signal is output to the adaptive processing unit 92.

The adaptive processing unit 92 performs an adaptive processing using an adaptive algorithm and design a control filter. In the adaptive processing, calculation is performed so that the entire system is optimized. In the present use example, the adaptive processing is operated so as to minimize the estimation error signal. That is, by minimizing the level of the estimation error signal, it is possible to realize active control of the place where the microphone 10 is installed. In the illustrated example, the control filter of the filter unit 93 is designed so that the operation of each actuator 7A is optimized. Specifically, the adaptive processing unit 92 outputs the filter coefficients of the control filter to the filter unit 93.

The filter unit 93 performs filtering using the control filter designed by the adaptive processing unit 92. A reference signal output from the reference microphone in the active control is input to the filter unit 93. As described in the first use example, this reference microphone may be separately provided or may also be served as the sensor module 1. The filter unit 93 filters the input reference signal and generate a drive signal of each actuator 7A. The generated drive signal is output to the corresponding actuator 7A, and each actuator 7A is driven.

### [Example Flow of Vibration Control Processing]

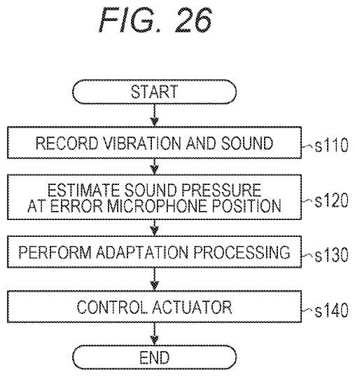

FIG. 26 is a flowchart illustrating a flow of active control processing in the active control system 9B. In the active control processing, first, the active control device 12 records vibration and sound (step S110). Specifically, the active control device 12 records module signals (a vibration recording signal and a sound pressure recording signal) output from the sensor module 1. Next, the active control device 12 estimates a sound pressure at an error microphone position (a place where the microphone 10 is installed) (step S120). Specifically, the sound pressure estimation unit 91 estimates the error signal using an estimation algorithm such as a neural network.

Next, the active control device 12 executes adaptive processing (step S130). Specifically, the adaptive processing unit 92 performs the adaptive processing so as to minimize the estimation error signal by using the sound pressure (estimation error signal) estimated by the sound pressure estimation unit 91. That is, a control filter for filtering the reference signal in the active control is designed (filter coefficients are calculated).

Then, the reference signal is filtered by the designed control filter, and each actuator 7A is controlled (step S140). By controlling each actuator 7A in this manner, it is possible to reduce noise at the place where the microphone 10 is installed. Note that the hardware configuration example of the information processing device that can be adopted in the measurement device 11, the active control device 12, and the like described above is as described in the first use example (see FIG. 20).

### Summary

As described above, in the present use example, the active control can be easily performed at low cost by using the sensor module 1 as described above. The sound pressure at the place where the microphone 10 is installed is estimated using the module signal recorded in the sensor module 1, and the adaptive processing is performed so that the sound pressure is minimized, whereby the sound at the place where the microphone 10 is installed can be controlled. Since the module signal (the vibration recording signal and the sound pressure recording signal) of each sensor module 1 is used for estimation of the sound pressure, accurate estimation can be performed, and active control can be performed satisfactorily. Since the sound pressure estimated in the adaptive processing is used, it is not necessary to install the microphone 10 (error microphone) in the operation phase, and the system can be simplified.

### 9. Third Use Example of Sensor Module

The sensor module 1 can also be used in applications different from the first use example and the second use example. For example, as a case where a noise claim occurs, a case where noise (conversation sound or the like) from a neighboring room is heard between conference rooms is conceivable. The present use example corresponds to such a case.

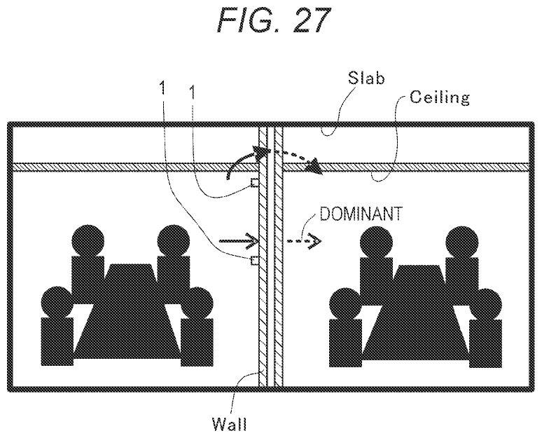

FIG. 27 illustrates a route example of noise transmission between adjacent conference rooms. For example, in the case of a building structure in which a wall partitioning the interior is provided up to the bottom of the floor slab of the upper floor as illustrated in the drawing, there is almost no sound leaking to the adjacent room via the ceiling, so that radiant energy (vibration→noise of sound) from the wall is dominant.

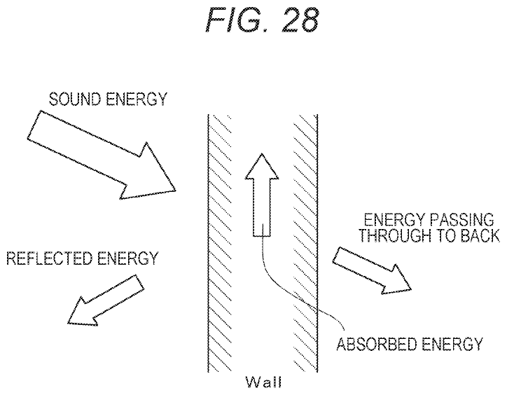

FIG. 28 is a diagram for explaining transmitted energy in a case where a wall is vibrated by sound, which causes noise. The generated sound energy is partially absorbed by the wall and partially reflected by the wall. Then, the rest passes through the wall. Therefore, the vibration of the wall is only required to be controlled so as to minimize the energy passing through the wall. For example, the systems of the first use example and the second use example described above can be applied to this vibration control. That is, the target object is only required to be a wall instead of the window glass W. Furthermore, in this case, it is only required to achieve noise reduction on the space side where the sensor module 1 is not provided. Specifically, it is only required to estimate the acoustic radiation power so that the acoustic radiation from the wall decreases, or to estimate the sound pressure at a specific position on the room side where the sound leaks. As described above, the space in which the active control is performed is not limited to the space in which the sensor module 1 is provided. As described above, it is possible to reduce noise in the adjacent room by eliminating the acoustic radiation from the wall to the adjacent room.

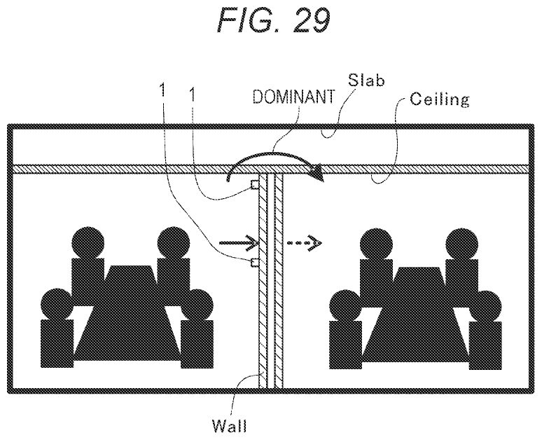

FIG. 29 illustrates a route example of noise transmission between other adjacent conference rooms. For example, as illustrated in the drawing, in the case of a building structure in which the wall partitioning the interior is provided only up to the ceiling and not below the floor slab of the upper floor, the sound leaks to the adjacent room via the ceiling, so that the noise (sound pressure) due to the leakage is dominant. That is, the dominant noise source changes between the case where the boundary wall exists up to below the slab (see FIG. 27) and the case where the boundary wall exists only up to below the ceiling (see the present drawing).

As described above, in a case where the noise due to the leakage is dominant, it is better to control the noise derived from the sound pressure of the leakage rather than to control the energy passing through the wall. Since the sensor module 1 can separate and extract the sound pressure and the particle velocity (or the vibration velocity) as described above, as illustrated in FIG. 29, the sensor module 1 is only required to be installed near the leakage location (near the ceiling in this example) to record the sound pressure, and to perform known active control of “sound→sound” illustrated in FIG. 1 (which may be either a feedforward control method or a feedback control method). That is, although detailed description is omitted here, a speaker or the like is only required to be controlled in a room where sound leaks to output sound that cancels the recorded sound pressure. Unlike the control using only the conventional acceleration sensor, the sensor module 1 has an advantage that “sound pressure+vibration velocity” can be recorded, so that such control can also be realized. Note that at least one of the present use example or another use example may be executed in combination so that the dominant sound can be handled in any case.

### Summary

As described above, in the present use example, the active control can be easily performed at low cost by using the sensor module 1 as described above. Since the sensor module 1 can record not only vibration but also sound pressure, the sensor module 1 can also be applied to active control of an aspect in which sound is recorded and processing is performed so as to cancel the recorded sound, unlike the case of using an acceleration sensor.

Furthermore, by performing the above-described processing, in a space where the sensor module 1 is not provided, it is possible to perform active control on sound in a space where the sensor module 1 is provided. In a case where the first use example is applied, the same effect as that of the first use example can be obtained, and in a case where the second use example is applied, the same effect as that of the second use example can be obtained.

### 10. Modifications

Although the embodiments of the present disclosure have been specifically described, the present disclosure is not limited to the above-described embodiments, and various modifications based on the technical idea of the present disclosure may be made. For example, various modifications to be described below may be made. Furthermore, one or a plurality of optionally selected aspects of the modifications to be described below may be appropriately combined. Furthermore, configurations, methods, processes, shapes, materials, numerical values, and the like of the above-described embodiments may be combined or exchanged with each other without departing from the gist of the present disclosure. Furthermore, one may be divided into two or more, and a part thereof may be omitted.

For example, in each use example, the active control may be performed in two stages such that the vibration of the window glass W or the wall that radiates sound is controlled by an actuator (the activators 7 and 7A or the like) to reduce noise, and moreover, the noise that cannot be removed is controlled by an actuator (for example, a speaker or the like).

Furthermore, for example, in each use example, the active control in the case of reducing noise is exemplified, but the present invention is not limited thereto, and can also be applied to an aspect of controlling the inside of the space to specific sound.

Furthermore, for example, the application is not limited to those of the above-described use examples, and various applications using at least one of sound pressure or vibration (particle velocity) can be supported. For example, the present disclosure may be used for active control of sounds inside and outside of vehicles, inside and outside of concert halls, inside of expressways, and the like.

Note that the present disclosure may also adopt the following configurations.

(1)

A sensor module including:
a first sensor unit that is installed on an object and measures a sound pressure;
a second sensor unit that is installed on the object and measures vibration; and
a signal processing unit that outputs, as module signals, two signals of a signal of a vibration component of the object and a signal of a sound pressure component obtained by removing the vibration component of the object from an output signal of the first sensor unit by using the output signal of the first sensor unit and an output signal of the second sensor unit.
   (2)

The sensor module according to (1),
in which the sensor module sets the output signal of the second sensor unit as a signal of a vibration component of the object, and
a signal obtained by subtracting the output signal of the second sensor unit from the output signal of the first sensor unit is set as a signal of the sound pressure component.
   (3)

The sensor module according to (1) or (2),
in which the first sensor unit and the second sensor unit are arranged at positions where vibrations of the object measured by the first sensor unit and the second sensor unit fall within a predetermined error range.
   (4)

The sensor module according to any one of (1) to (3),
in which the first sensor unit and the second sensor unit are MEMS sensors.
   (5)

The sensor module according to any one of (1) to (4),
in which the first sensor unit is a microphone having a sound hole, and
the second sensor unit is a microphone in which a sound hole of a microphone having the same structure as the first sensor unit is closed.
   (6)

The sensor module according to any one of (2) to (5),
in which the signal processing unit includes a filter processing unit that absorbs a difference in vibration detection characteristics between the first sensor unit and the second sensor unit, and performs the subtraction using an output signal in which the difference is absorbed by the filter processing unit.
   (7)

The sensor module according to any one of (1) to (6),
in which the sensor module has a structure in which the second sensor unit and the first sensor unit are sequentially stacked and installed on the object.
   (8)

The sensor module according to any one of (1) to (7),
further including a memory that stores the two module signals output from the signal processing unit.
   (9)

The sensor module according to any one of (1), (3) to (5), (7), and (8),
further including a correction processing unit that corrects the output signal of the first sensor unit and the output signal of the second sensor unit according to a recording ratio of vibration due to the sound pressure in the second sensor unit.
   (10)

An active control device
controlling an actuator in an active control system by using a module signal output from a sensor module, the sensor module including: a first sensor unit that is installed on an object and measures a sound pressure; a second sensor unit that is installed on the object and measures vibration; and a signal processing unit that outputs, as module signals, two signals of a signal of a vibration component of the object and a signal of a sound pressure component obtained by removing the vibration component of the object from an output signal of the first sensor unit by using the output signal of the first sensor unit and an output signal of the second sensor unit.
   (11)

The active control device according to (10),
in which the active control device calculates acoustic intensity of an installation place of the sensor module by using the two module signals, estimates acoustic radiation power of the object from the calculated acoustic intensity, and performs adaptive processing of minimizing the acoustic radiation power by using the estimated acoustic radiation power.
   (12)

The active control device according to (10),
in which the active control device estimates an estimation error signal by an estimation algorithm using the two module signals and an error signal measured by an error microphone, and performs adaptive processing of minimizing the estimation error signal using the estimated estimation error signal.
   (13)

The active control device according to (10),
in which the active control device performs adaptive processing of minimizing the signal of the sound pressure component by using the signal of the sound pressure component of the two module signals.
   (14)

An active control method
controlling an actuator in an active control system by using a module signal output from a sensor module, the sensor module including: a first sensor unit that is installed on an object and measures a sound pressure; a second sensor unit that is installed on the object and measures vibration; and a signal processing unit that outputs, as module signals, two signals of a signal of a vibration component of the object and a signal of a sound pressure component obtained by removing the vibration component of the object from an output signal of the first sensor unit by using the output signal of the first sensor unit and an output signal of the second sensor unit.
   (15)

A program for causing a computer to execute processing of
controlling an actuator in an active control system by using a module signal output from a sensor module, the sensor module including: a first sensor unit that is installed on an object and measures a sound pressure; a second sensor unit that is installed on the object and measures vibration; and a signal processing unit that outputs, as module signals, two signals of a signal of a vibration component of the object and a signal of a sound pressure component obtained by removing the vibration component of the object from an output signal of the first sensor unit by using the output signal of the first sensor unit and an output signal of the second sensor unit.

### REFERENCE SIGNS LIST

1, 1A, 1B, 1C, 1D Sensor module
2 First sensor unit
3 Second sensor unit
4, 4B, 4C, 4D Signal processing unit
5B, 9B Active control system
7, 7A Actuator
8, 12 Active control device
24, 34 Sound hole
41 Subtraction processing unit
42, 42C Filter processing unit
43 Correction processing unit
51 Acoustic radiation power estimation unit
52, 92 Adaptive processing unit
53, 93 Filter unit
91 Sound pressure estimation unit
T Object

1. A sensor module comprising:
a first sensor unit that is installed on an object and measures a sound pressure;
a second sensor unit that is installed on the object and measures vibration; and
a signal processing unit that outputs, as module signals, two signals of a signal of a vibration component of the object and a signal of a sound pressure component obtained by removing the vibration component of the object from an output signal of the first sensor unit by using the output signal of the first sensor unit and an output signal of the second sensor unit.

2. The sensor module according to claim 1,
wherein the sensor module sets the output signal of the second sensor unit as a signal of a vibration component of the object, and
a signal obtained by subtracting the output signal of the second sensor unit from the output signal of the first sensor unit is set as a signal of the sound pressure component.

3. The sensor module according to claim 1,
wherein the first sensor unit and the second sensor unit are arranged at positions where vibrations of the object measured by the first sensor unit and the second sensor unit fall within a predetermined error range.

4. The sensor module according to claim 1,
wherein the first sensor unit and the second sensor unit are MEMS sensors.

5. The sensor module according to claim 1,
wherein the first sensor unit is a microphone having a sound hole, and
the second sensor unit is a microphone in which a sound hole of a microphone having the same structure as the first sensor unit is closed.

6. The sensor module according to claim 2,
wherein the signal processing unit comprises a filter processing unit that absorbs a difference in vibration detection characteristics between the first sensor unit and the second sensor unit, and performs the subtraction using an output signal in which the difference is absorbed by the filter processing unit.

7. The sensor module according to claim 1,
wherein the sensor module has a structure in which the second sensor unit and the first sensor unit are sequentially stacked and installed on the object.

8. The sensor module according to claim 1,
further comprising a memory that stores the two module signals output from the signal processing unit.

9. The sensor module according to claim 1,
further comprising a correction processing unit that corrects the output signal of the first sensor unit and the output signal of the second sensor unit according to a recording ratio of vibration due to the sound pressure in the second sensor unit.

10. An active control device
controlling an actuator in an active control system by using a module signal output from a sensor module, the sensor module comprising:
a first sensor unit that is installed on an object and measures a sound pressure;
a second sensor unit that is installed on the object and measures vibration; and
a signal processing unit that outputs, as module signals, two signals of a signal of a vibration component of the object and a signal of a sound pressure component obtained by removing the vibration component of the object from an output signal of the first sensor unit by using the output signal of the first sensor unit and an output signal of the second sensor unit.

11. The active control device according to claim 10,
wherein the active control device calculates acoustic intensity of an installation place of the sensor module by using the two module signals, estimates acoustic radiation power of the object from the calculated acoustic intensity, and performs adaptive processing of minimizing the acoustic radiation power by using the estimated acoustic radiation power.

12. The active control device according to claim 10,
wherein the active control device estimates an estimation error signal by an estimation algorithm using the two module signals and an error signal measured by an error microphone, and performs adaptive processing of minimizing the estimation error signal using the estimated estimation error signal.

13. The active control device according to claim 10,
wherein the active control device performs adaptive processing of minimizing the signal of the sound pressure component by using the signal of the sound pressure component of the two module signals.

14. An active control method controlling an actuator in an active control system by using a module signal output from a sensor module, the sensor module comprising:
a first sensor unit that is installed on an object and measures a sound pressure;
a second sensor unit that is installed on the object and measures vibration; and
a signal processing unit that outputs, as module signals, two signals of a signal of a vibration component of the object and a signal of a sound pressure component obtained by removing the vibration component of the object from an output signal of the first sensor unit by using the output signal of the first sensor unit and an output signal of the second sensor unit.

15. A program for causing a computer to execute processing of controlling an actuator in an active control system by using a module signal output from a sensor module, the sensor module comprising:
a first sensor unit that is installed on an object and measures a sound pressure;
a second sensor unit that is installed on the object and measures vibration; and
a signal processing unit that outputs, as module signals, two signals of a signal of a vibration component of the object and a signal of a sound pressure component obtained by removing the vibration component of the object from an output signal of the first sensor unit by using the output signal of the first sensor unit and an output signal of the second sensor unit.
